(19) United States
(12) Patent Application Publication
(10) Pub. No.: US 2016/0116064 A1
(43) Pub. Date: Apr. 28, 2016

(54) SEALING ASSEMBLY BETWEEN COMPONENTS

(71) Applicant: Caterpillar Inc., Peoria, IL (US)

(72) Inventors: Scott D. Larson, Brimfield, IL (US); Richard A. Matzelle, Peoria, IL (US); Cole C. Deichert, Washington, IL (US)

(73) Assignee: Caterpillar Inc., Peoria, IL (US)

(21) Appl. No.: 14/990,829

(22) Filed: Jan. 8, 2016

(51) Int. Cl. F16J 15/14; G02F 1/01; F16J 15/10

(52) U.S. Cl. CPC F16J 15/14; F16J 15/10; G02F 1/0107

(57) ABSTRACT

A sealing assembly between a first component and a second component is provided. The sealing assembly includes a first flange extending from the first component. The first flange includes a first mating surface. The sealing assembly further includes a second flange extending from the second component. The second flange includes a second mating surface adapted to abut the first mating surface of the first flange. The second flange further includes a slanted surface extending from the second mating surface at an angle with respect to the second mating surface of the second flange. The slanted surface is being disposed at an angle with respect to the second mating surface of the second flange. The sealing assembly further includes a sealant disposed between the first mating surface of the first flange and the second mating surface of the second flange.

### TECHNICAL FIELD

The present disclosure relates to a sealing assembly, and more particularly relates to the sealing assembly between a first component and a second component in a display unit.

### BACKGROUND

Generally, a display unit of a computing device may be made by coupling two or more components. The components are coupled to each other via fastening members. Further, a gasket sealant is disposed between mating surfaces of the components to provide a tight coupling between the components. In an example, the display unit of the computing device is formed by coupling connector plate, which may be made from a plastic with an outer cover of the display unit. The gasket sealant is provided between mating surfaces of the outer cover and the connector plate for providing tight coupling therebetween. During coupling of the components by the fastening members, thickness of a film defined by the gasket sealant between two adjacent components may be relatively thin, as excess gasket sealant comes out of the mating surfaces of the components. Less quantity of the sealant may result in relatively weaker joints that may not be able to withstand surrounding environmental conditions, such as a temperature. Further, excess gasket sealant comes out of the mating surfaces need to be cleaned, which may lead to complex manufacturing process.

JP Patent Publication Number 2009/243084 (the '084 application) discloses a seal part structure capable of preventing cracks and crush from occurring in a concrete structure by suppressing the amount of a seal material at the corners of the concrete structure by a simple structure. This seal part structure comprises a seal groove formed in the side surface (inter segment joint and inter ring joint) of a segment having the corners and the seal material disposed in the seal groove. A relief space for absorbing the excess amount of the seal material is formed in the seal groove at the corner. However, the '084 application does not provide a desired clearance between components, when both the components are coupled via fastening members.

### SUMMARY OF THE DISCLOSURE

In one aspect of the present disclosure, a sealing assembly between a first component and a second component is provided. The sealing assembly includes a first flange extending from the first component. The first flange has a first mating surface. The sealing assembly further includes a second flange extending from the second component. The second flange includes a second mating surface adapted to abut the first mating surface of the first flange. The second flange further includes a slanted surface extending from the second mating surface at an angle with respect to the second mating surface of the second flange. The sealing assembly further includes a sealant disposed between the first mating surface of the first flange and the second mating surface of the second flange. The slanted surface of the second flange and the first mating surface of the first flange are adapted to define a space therebetween to accommodate the sealant therein, when the first component and the second component are coupled with each other. The slanted surface along with the sealant is adapted to provide a controlled gap between the first mating surface of the first flange and the second mating surface of the second flange, when the second component is coupled to the first component by a fastening member.

Other features and aspects of this disclosure will be apparent from the following description and the accompanying drawings.

### BRIEF DESCRIPTION OF THE DRAWINGS

FIG. 1 is a schematic sectional view of a display unit having a first component and a second component coupled with the first component, according to an embodiment of the present disclosure;

FIG. 2 is an enlarged sectional view of the first component coupled to the second component of the display unit of FIG. 1 with a sealing assembly; and

FIGS. 3A and 3B shows an assembly of the first component with the second component.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

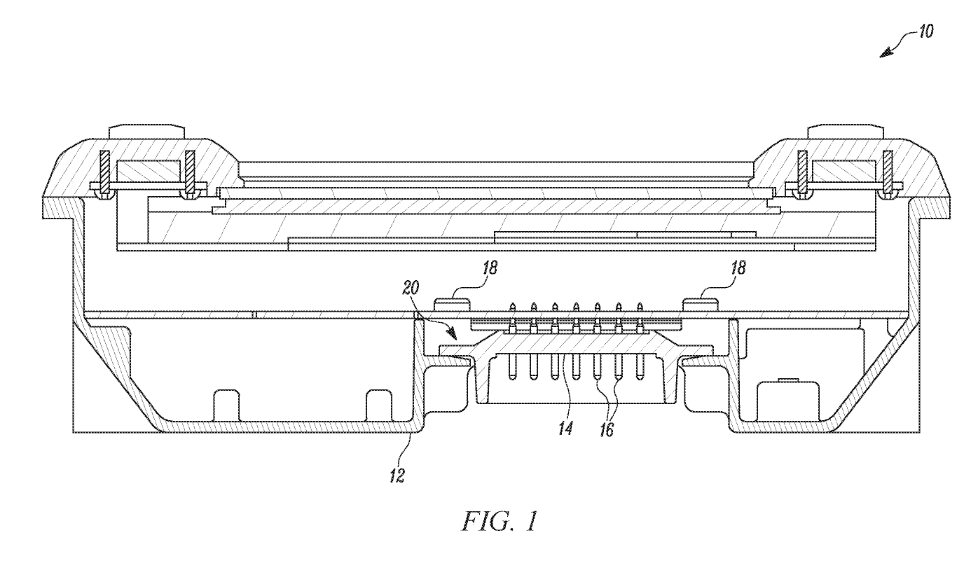

FIG. 1 illustrates a schematic sectional view of a display unit 10 having a housing 12 and a connector plate 14 coupled to the housing 12. For illustration purpose of the present disclosure, the display unit 10 used in an operator cabin of a machine, such as on road vehicle and off road vehicle is shown in FIG. 1. However, it may be understood that the present disclosure may be implemented in various applications where two or more components may be coupled via sealant material. In one example, the present disclosure may be implemented where a transparent glass or a mirror glass need to be affixed to housing made from materials, such as aluminum, wood, plastic or any other material known in the art. The display unit 10 is provided in the operator cabin of the machine to present various operating parameters of the machine. In an example, the display unit 10 may be provided to display performance parameters various components of the machine, and surrounding image of the machine captured by cameras.

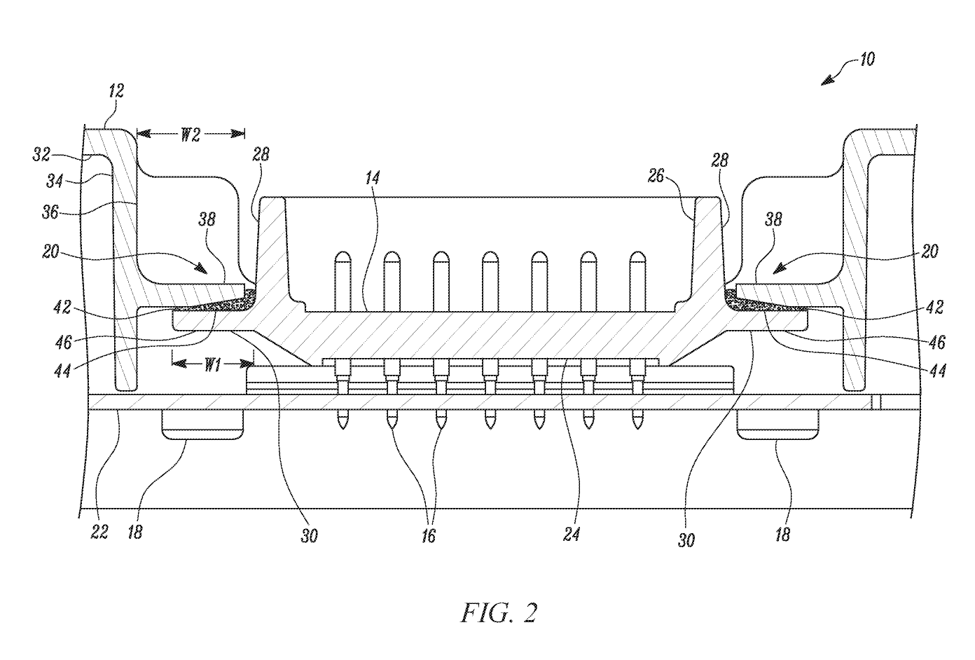

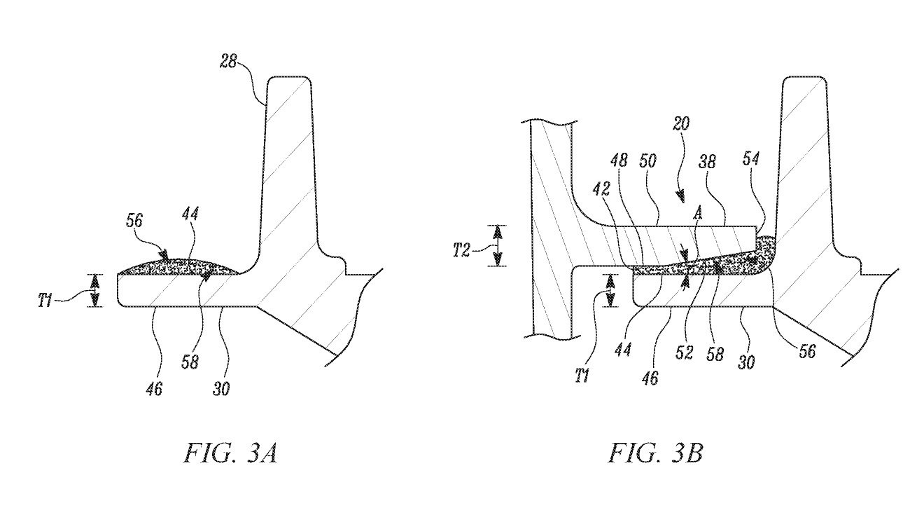

The housing 12 of the display unit 10 is adapted to enclose various electric and electronic components, such circuit boards of the display unit 10. The housing 12 may be made from materials, such as metals, alloys, plastics, fiber material, wood, or a combination thereof. The housing 12 may be coupled to a dash board or a control console of the operator cabin via fastening members 18, such as bolts and nuts. A screen of the display unit 10, such as LED or LCD, may be attached to the housing 12 by various fastening methods known in the art. The connector plate 14 is coupled to the housing 12 from behind the screen. The connector plate 14 may be made from materials, such as metals, alloys, plastics, fiber material, wood, or a combination thereof. In an example, the connector plate 14 of the display unit 10 may include an interface configured for connecting to external device, such as controller of the machine. The interface includes multiple connector pins 16 configured to provide inputs to or to retrieve outputs from the display unit 10. The connector plate 14 is coupled to the housing member via fastening members 18. Further, the connector plate 14 is coupled to the housing 12 by a sealing assembly 20, which will be describe in detail in FIGS. 2 and 3, according to the present disclosure. The connector plate 14 is hereinafter referred to as ‘the first component 14’ and the housing is hereinafter referred to as ‘the second component 12’ for illustration purpose of the present disclosure, and to describe the present disclosure without limiting to the display unit 10 shown in FIG. 1.

FIG. 2 illustrates an enlarged view of the first component 14 coupled with the second component 12 of the display unit 10 of FIG. 1. In an example, the first component 14 may be made of aluminum and the second component 12 is made from plastic. The second component 12 is coupled to the first component 14 by the fastening members 18. However, it may be understood that the first component 14 may be connected to the second component 12 of the display unit 10 using various methods including, but not limited to, riveting.

The display unit 10 further includes a printed circuit board assembly 22. The printed circuit board assembly 22 is a thin plate containing various electronic components. Further, the first component 14 and the second component 12 together define the sealing assembly 20 therebetween to couple with each other. The first component 14 includes a base 24 and a wall member 26 extending vertically from the base 24. The wall member 26 includes an outer surface 28 for the first component 14. The first component 14 further includes a first flange 30 extending from the outer surface 28 of the wall member 26 such that the wall member 26 and the first flange 30 defines an ‘L’ shape cross section as shown in FIG. 2. Further, the first flange 30 extends from the outer surface 28 of the wall member 26 such that the first flange 30 defines a first width ‘W1’. The multiple connector pins 16 are disposed in the base 24 to contact with the printed circuit board assembly 22. The second component 12 includes a base portion 32 and a side portion 34 extending vertically down from the base portion 32. The side portion 34 defines an inner surface 36 for the second component 12. The second component 12 further includes a second flange 38 extending from the inner surface 36 of the side portion 34 such that the side portion 34 and the second flange 38 define an ‘L’ shape cross section as shown in FIG. 2. Further, the second flange 38 extends horizontally from the inner surface 36 of the side portion 34 such that the second flange 38 defines a second width ‘W2’. The first flange 30 of the first component 14 and the second flange 38 of the second component 12 are adapted to contact each other during coupling of the first component 14 and the second component 12. Further, the first flange 30 and the second flange 38 are coupled with each other via fastening member 18. The manner in which the sealing assembly 20 aids in maintaining a controlled gap 42 between the first flange 30 of the first component 14 and the second flange 38 of the second component 12 during coupling of the first component 14 and the second component 12 is explained in FIG. 3.

FIGS. 3A and 3B illustrate an assembly of the first component 14 with the second component 12. Referring to FIGS. 2, 3A, and 3B, the sealing assembly 20 includes the first flange 30 of the first component 14 and the second flange 38 of the second component 12. The first flange 30 includes a first mating surface 44 and a first surface 46 distal to the first mating surface 44. The first mating surface 44 and the first surface 46 define a first thickness ‘T1’ for the first flange 30. The first mating surface 44 is a planar surface, as shown in FIG. 3. However, it may be understood that the first mating surface 44 may be a non-planar surface. The second flange 38 includes a second mating surface 48 adapted to abut the first mating surface 44 of the first flange 30. The second mating surface 48 is also a planar surface corresponding to the first mating surface 44. However, in another example, the second mating surface 48 may be a non-planar surface adapted to abut any shape of the first mating surface 44. The second flange 38 further includes a second surface 50 distal to the second mating surface 48. The second mating surface 48 and the second surface 50 define a second thickness ‘T2’ for the second flange 38. The second flange 38 further includes a slanted surface 52 extending from the second mating surface 48 at an angle “A” with respect to the second mating surface 48 of the second flange 38. In one example, the second mating surface 48 defines an outer edge 54, as such the slanted surface 52 extends from the outer edge 54 of the second mating surface 48 and taper towards a peripheral edge of the second flange 38. Thus the second thickness ‘T2’ of the second flange 38 at the outer edge 54 of the second mating surface 48 becomes lesser at the peripheral edge of the second flange 38. The angle “A” with respect to the second mating surface 48 of the second flange 38 based on various parameters including, but not limited to, the first width ‘W1’ of the first flange 30, the second width ‘W2’ of the second flange 38, and the second thickness ‘T2’ of the second flange 38. In an example, the slanted surface 52 may have the angle “A” between 30 and 45 degree.

The sealing assembly 20 further includes a sealant 56 disposed between the first mating surface 44 of the first flange 30 and the second mating surface 48 of the second flange 38. Further, the slanted surface 52 of the second flange 38 and the first mating surface 44 of the first flange 30 are adapted to define a space 58 therebetween to accommodate the sealant 56 therein during coupling of the first component 14 and the second component 12. In one example, the sealant 56 is RTV (room temperature vulcanized silicone). In another example, the sealant 56 may be any other liquid or semi-solid sealant material known in the art.

During assembly of the first component 14 and the second component 12, the sealant 56 may be disposed on the first mating surface 44 of the first flange 30. Further, the second flange 38 of the second component 12 is disposed on the first flange 30 of the first component 14 such that the first mating surface 44 and the second mating surface 48 are aligned each other to couple the second component 12 with the first component 14 via the fastening members 18. In another example, the sealant 56 may be disposed on the second mating surface 48 of the second flange 38, or both the first and second mating surfaces 44, 48. During tightening of the fastening members 18, excess amount of the sealant 56 may flow to the space 58 defined by the slanted surface 52 of the second flange 38 and the first mating surface 44 of the first flange 30 accommodated therein. Thus, the slanted surface 52 in combination with the sealant 56 is adapted to provide the controlled gap 42 between the first mating surface 44 of the first flange 30 and the second mating surface 48 of the second flange 38.

In another embodiment, the slanted surface 52 may be replaced with a circular surface to accommodate additional sealant 56. As such, the circular surface may further facilitate controlling of the gap between the first mating surface 44 of the first flange 30 and the second mating surface 48 of the second flange 38. In yet another embodiment, the slanted surface 52 may be provided in the first flange 30 instead of the second flange 38 based on the application of the display unit 10 and coupling arrangement of the first component 14 and the second component 12.

### INDUSTRIAL APPLICABILITY

The present disclosure relates to the sealing assembly 20 defined between the first component 14 and the second component 12. The sealing assembly 20 of the present disclosure may be provided on the first component 14 or the second component 12 that is to be coupled with the first component 14. The slanted surface 52 is defined on the second component 12 such that the sealant 56 is received into the space 58 defined by the sealing assembly 20 in order to provide the controlled gap 42 and a tight coupling between the first component 14 and the second component 12.

Thus, the space 58 defined by the slanted surface 52 of the second flange 38 and the first mating surface 44 of the first flange 30 is filled with the sealant 56. Further, the sealant 56 is completely filled between the first mating surface 44 of the first flange 30 and the second mating surface 48 of the second flange 38 to provide the controlled gap 42 and the tight coupling. The space 58 defined by the sealing assembly 20 between the first component 14 and the second component 12 may accommodate a larger amount of the sealant 56 compared to known sealing assemblies. It may be contemplated that although the sealing assembly 20 is described in relation to the first component 14 and the second component 12 of the display unit 10, the sealing assembly 20 may be utilized in other components for providing the controlled gap 42. Dimension of the slanted surface 52 may vary based on various applications. Further, the sealing assembly 20 may include more than one slanted surface 52 based on the application.

Further, the excess amount of the sealant 56 accommodated within the space 58 increase bonding strength between the first component 14 and the second component 12. Also, the sealant 56 defined between the slanted surface 52 and the first mating surface 44 provides additional thickness to a layer of the sealant 56 formed between the first mating surface 44 and the second mating surface 48. Thus, a bonding strength between the first component 14 and the second component 12 may be still maintained in adverse ambient conditions, such as higher temperature of the operator cabin. As the excess amount of the sealant 56 material is stored within the space 58 during coupling of the first component 14 and the second component 12, additional cleaning work, which otherwise required if the excess sealant 56 comes out of the first and second mating surfaces 44, 48 of the first and second components 14, 12, respectively, may be avoided. Thus, a time required for manufacturing of the display unit 10 may be reduced, without affecting a quality of the bonding between the first component 14 and the second component 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A sealing assembly between a first component and a second component, the sealing assembly comprising:
a first flange extending from the first component, wherein the first flange having a first mating surface;
a second flange extending from the second component, wherein the second flange includes:
a second mating surface adapted to abut the first mating surface of the first flange; and
a slanted surface extending from the second mating surface at an angle with respect to the second mating surface of the second flange; and
a sealant disposed between the first mating surface of the first flange and the second mating surface of the second flange, wherein the slanted surface of the second flange and the first mating surface of the first flange are positioned to define a space therebetween to accommodate the sealant material therein, when the first component and the second component are coupled with each other,
wherein the slanted surface along with the sealant material is adapted to provide a controlled gap between the first mating surface of the first flange and the second mating surface of the second flange, when the second component is coupled to the first component by a fastening member.
